(19) United States
(12) Patent Application Publication
(10) Pub. No.: US 2026/0010944 A1
(43) Pub. Date: Jan. 8, 2026

(54) E-CONSENT CAPTURE

(71) Applicant: BREAD FINANCIAL PAYMENTS, INC., Columbus, OH (US)

(72) Inventors: Jess LAWRENCE, Westerville, OH (US); Chris ANDERSON, Powell, OH (US)

(73) Assignee: BREAD FINANCIAL PAYMENTS, INC., Columbus, OH (US)

(21) Appl. No.: 19/263,421

(22) Filed: Jul. 8, 2025

Related U.S. Application Data
(60) Provisional application No. 63/668,459, filed on Jul. 8, 2024.

(51) Int. Cl. G06Q 40/03

(52) U.S. Cl. CPC G06Q 40/03

(57) ABSTRACT

A system and method for associate-assisted e-consent capture. An associate assists a user with obtaining a credit card. The associate's device is used with the user's device to proceed with the credit card application. The credit card application process is completed and the e-sign from the user is obtained using the associate's device.

### CROSS-REFERENCE TO RELATED APPLICATIONS

This application claims the benefit of and priority to co-pending U.S. Provisional Patent Application No. 63/668,459, filed Jul. 8, 2024, entitled “E-CONSENT CAPTURE” by Jess Lawrence, et al., assigned to the assignee of the present application, and having Attorney Docket No. BFP-260.PRO, which is herein incorporated by reference in its entirety.

### BACKGROUND

Presently, the law requires a paper credit card agreement (CCA) including terms and conditions (T&C's) be provided to a person applying for a credit account at a point of sale (POS) in a store.

Indubitably, there are a number of problems incurred in providing paper CCA's. These problems include material problems and incurred costs.

In general, incurred costs refers to printing costs, shipping/distribution costs, management costs (e.g., version tracking, in-store deployment/upkeep, etc.), and the like.

For example, when dealing with multiple branded credit accounts, each brand's CCA will usually include brand specific identifier such as a logo, marketing slogan, or the like. As such, the printing costs cannot be consolidated using larger print runs for multiple brands. Moreover, each brand will often require a different number of printed CCA's due to the differing number of retail locations.

Deleteriously, the printing, distributing, and management costs are not just a one-time expense. Instead, the costs are repeatably incurred each time there is a material change. For example, an update to brand specific aspects (e.g., logos, marketing slogans, etc.), holiday/events for a given brand, changes to the T&C's, and the like.

Moreover, anytime the material change occurs, it is paramount to ensure that any pre-existing printed media containing the now erroneous material is removed from circulation. In the case of a small business, there may only be tens or even hundreds of pre-existing printed media that need to be removed from circulation. However, in the case of a large business (or a plurality of businesses) there may be thousands, hundreds of thousands, or even millions of pre-existing printed media that will all simultaneously pass their expiration/valid date. Further, the pre-existing printed media could be in hundreds or thousands of locations spread across a large geographical area that could include states, nations, continents, etc. In many cases, it is also important to track the destruction and/or replacement of the out-of-date printed media for regulatory purposes.

Thus, finding, identifying, removing, replacing and/or destroying all of the pre-existing printed media is a herculean challenge that can encompass many work-hours and incurs significant costs.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a mobile device, in accordance with an embodiment of the present invention.

FIG. 2 is a top plan view of a store utilizing the e-consent capture, in accordance with an embodiment of the present invention.

FIG. 3 is a plurality of screen shots illustrating a process for performing e-consent capture, in accordance with an embodiment of the present invention.

FIG. 4 is a block diagram of the content stored by the credit account provider computer system as part of the e-consent capture, in accordance with an embodiment of the present invention.

FIG. 5 is a set of GUIs provided on an associate's device, in accordance with an embodiment of the present invention.

FIG. 6 is a GUI provided on an associate's device, in accordance with an embodiment of the present invention.

FIG. 7 is a GUI provided on a user's device, in accordance with an embodiment of the present invention.

FIG. 8 is a set of GUIs provided on an associate's device, in accordance with an embodiment of the present invention.

FIG. 9 is a GUI provided on an associate's device, in accordance with an embodiment of the present invention.

FIG. 10 is a set of GUIs provided on an associate's device, in accordance with an embodiment of the present invention.

FIG. 11 is a GUI provided on an associate's device, in accordance with an embodiment of the present invention.

FIG. 12 is a set of GUIs provided on a user's device, in accordance with an embodiment of the present invention.

FIG. 13 is a set of GUIs provided on an associate's device, in accordance with an embodiment of the present invention.

FIG. 14 is a GUI provided on an associate's device, in accordance with an embodiment of the present invention.

FIG. 15 is a set of GUIs provided on an associate's device, in accordance with an embodiment of the present invention.

FIG. 16 is a GUI provided on an associate's device, in accordance with an embodiment of the present invention.

FIG. 17 is a set of GUIs provided on a user's device, in accordance with an embodiment of the present invention.

FIG. 18 is a set of GUIs provided on an associate's device, in accordance with an embodiment of the present invention.

FIG. 19 is a GUI provided on an associate's device, in accordance with an embodiment of the present invention.

FIG. 20 is a flow chart of steps, in accordance with an embodiment of the present invention.

FIG. 21 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussion, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “deciding”, “determining”, “interacting”, “searching”, “pinging” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

It should be appreciated that the obtaining or accessing of information conforms to applicable privacy laws (e.g., federal privacy laws, state privacy laws, etc.).

Embodiments disclosed herein provide a novel method for obtaining digital consent that meets or exceeds the legal reasoning that presently dictates the paper CCA requirement.

In one embodiment, the digital consent is obtained via a user's mobile device interacting with a capturable code. Once the interaction is initiated, the user is presented with a digital version of the CCA's. After receiving the CCA's, the user will be able to provide a digital consent to the CCA's. In addition to the user providing the digital consent to the CCA's, the digital consent will be timestamped. The digital consent is electronically delivered to the credit account provider where it will be stored in place of the paper CCA.

### Operation

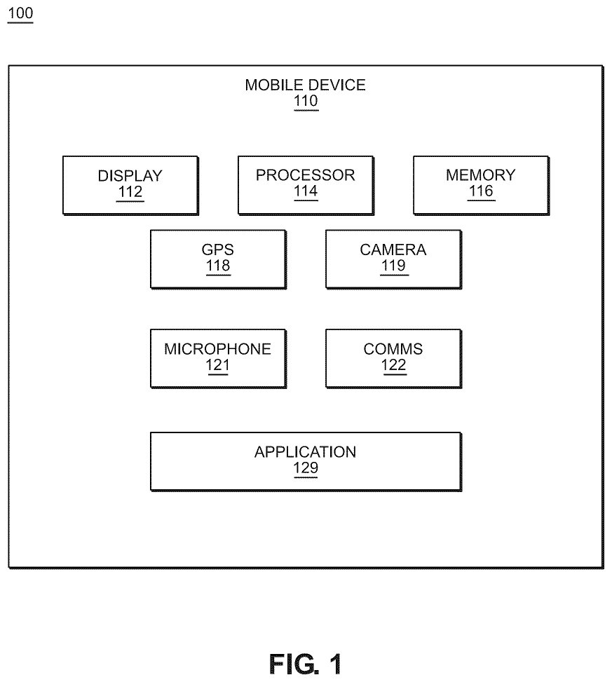

Referring now to FIG. 1, a block diagram of a mobile device 110 is shown. Although a number of components are shown as part of mobile device 110, it should be appreciated that other, different, more, or fewer components may be found on mobile device 110.

In general, mobile device 110 is an example of a customer's mobile device. Mobile device 110 could be a mobile phone, a smart phone, a tablet, a smart watch, a piece of smart jewelry, smart glasses, or other user portable devices having wireless connectivity and display capability. In one embodiment, mobile device 110 is capable of broadcasting and receiving via at least one network, such as, but not limited to, WiFi, Cellular, Bluetooth, NFC, and the like. In one embodiment, mobile device 110 optionally includes some or all of: a display 112, a processor 114, a memory 116, a GPS 118, a camera 119, a microphone 121, a communications capability 122, one or more applications 129, and the like. In one embodiment, the location of mobile device 110 may be determined within a given radius, such as the broadcast range of an identified beacon, a WiFi hotspot, overlapped area covered by a plurality of mobile telephone signal providers, or the like.

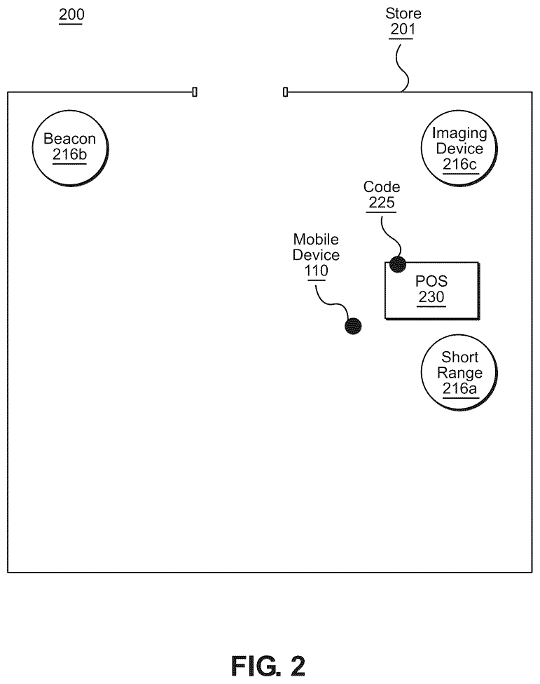

Referring now to FIG. 2, a top plan view 200 of a store 201 is shown in accordance with an embodiment. In general, store 201 is a physical location that provides goods for sale.

In one embodiment, store 201 includes one or more electronic devices such as, but not limited to: short-range device 216a, beacon 216b, POS 230, imaging device 216c, and the like. In one embodiment, store 201 includes code 225.

In one embodiment short-range device 216a is an RFID reader, an NFC device, a Bluetooth device, or the like. In general, short-range device 216a refers to a single device or a plurality of devices. In operation, short-range device 216a is configured to wirelessly communicate with mobile device 110 across short ranges such as, for example, within 5 feet of the POS 230. In one embodiment, short-range device 216a could be part of a functionality that already exists in the computer system of POS 230, a hardware device (such as a dongle, display, reader, or the like) that is coupled with POS 230, located within transmission range of POS 230, etc.

In one embodiment, beacon 216b is an iBeacon™, which is an indoor positioning system from Apple Inc. In general, beacon 216b refers to a single beacon or a plurality of beacons. In operation, beacon 216b is configured to be communicatively coupled with mobile device 110, such as via near field communication (NFC), Bluetooth, Wi-Fi, or the like. For example, the iBeacon is a low-powered, low-cost transmitter that can notify nearby iOS and/or Android devices of their presence. Although a specific example is provided, the one or more beacons are not limited to only that brand. Different beacons from other companies would also be acceptable. In another embodiment, beacon 216b is a wireless router. In one embodiment, beacon 216b could be part of a functionality that already exists in the computer system of POS 230, a hardware device coupled with POS 230, etc.

In one embodiment, imaging device 216c is a POS 230 image capturing device, a surveillance camera, or any image or video capturing device that can obtain a usable image or video. In general, imaging device 216c refers to a single device or a plurality of devices. In one embodiment, imaging device 216c will capture one or more images of the user at the POS 230. In one embodiment, the imaging device 216c would be queried for an image at, or within a given range inclusive of the time identified by a digital timestamp. In one embodiment, the queried imagery is included in the digital consent file delivered to the credit account provider. In one embodiment, imaging device 216c would provide the captured information to the credit account provider computer system via a network connection, such as, the mobile network, Wi-Fi, or the like.

In one embodiment, a code 225 is located by the POS 230. In one embodiment, code 225 is displayed by a display coupled with POS 230. In general, code 225 refers to a code such as a 1D code, 2D code (bar code, quick-response (QR) code, UPC, visual images, etc.), 3D code, sound code, picture code, video code, or the like.

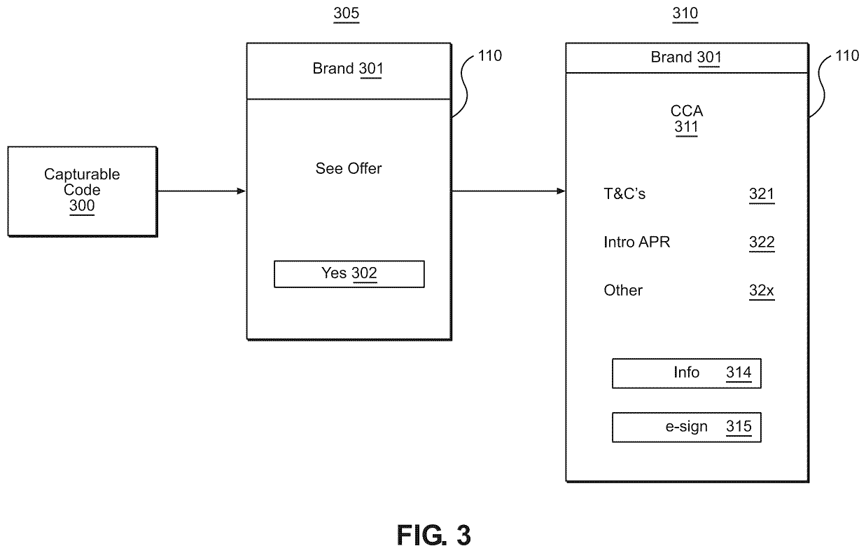

Referring now to FIG. 3, a plurality of screen shots illustrating a process for performing e-consent capture is shown in accordance with an embodiment.

In one embodiment, at the POS 230, a credit application is offered in the form of a capturable code 300 to mobile device 100.

In one embodiment, the capturable code 300 is obtained from code 225. In another embodiment, the capturable code 300 is broadcast from the short-range device 216a, beacon 216b, and/or POS 230. In general, the capturable code 300 could be captured by the user's mobile device 110 using one or more of the camera 119, microphone 121, wireless communications 122, or the like.

In one embodiment, as shown in screen capture 305, the result of the user's mobile device 110 receiving the capturable code is the presentation of an electronic message (e.g., a displayed message, website message, text message, email, etc.) that includes a selectable box 302 (or a link) to access a digital version of the CCA. In one embodiment, the selectable box 302 is a consent box. In one embodiment, the electronic message also includes the brand identifier 301.

In one embodiment, since the electronic message is obtained from instructions provided in the capturable code 300, the initial generated electronic message will include whatever information the capturable code requested when deployed by the appropriate agency. Such information could include a request for user ID information, a request for device ID information, a generation of metadata associated with the electronic message that includes device ID information, location information, etc. In one embodiment, the automatic generation of the electronic message from the interaction with the capturable code could include automatic insertion of one or more pieces of customer or device information from the memory of the mobile device, a request for authorization to send an email with the automatically inserted information, a request for manual input of one or more of the pieces of information, a combination of automatic and manually input information, or the like.

With reference now to screen capture 310, after interacting with selectable box 302 the CCA 311 is presented. In general, CCA 311 includes information related to obtaining, using, and managing the credit card account. For example, in one embodiment, the CCA information 311 will include information such as, but not limited to, T&Cs 321, introductory APR 322, and/or other information 32x such as compliance aspects, applicable laws, introductory rewards, fees, overage charges, and/or the like.

Once the CCA 311 information is reviewed at least one information block 314 is provided. In one embodiment, ID information 314 is the customer's last name. In one embodiment, the ID information 314 includes last name, phone number, and email address.

In one embodiment, ID information 314 will include user information such as, but not limited to: name, address, zip code, social security number or portion thereof, driver's license number or portion thereof, or the like that is used to identify a specific user.

In one embodiment, ID information 314 will include one or more device ID characteristics such as: a telephone number, a serial number, an international mobile equipment identity (IMEI), an integrated circuit card identifier (ICCID) (e.g., the SIM card number), a mobile equipment identifier (MEID), a secure element chipset identify (SEID), a media access control (MAC) address, an Internet protocol (IP) address, a universal unique identifier (UUID), a model number, a product number, a serial number, or the like.

In one embodiment, ID information 314 will include information requests for a combination of user ID and device ID types.

Once the ID information 314 is provided the e-sign button 315 (link, etc.) will be available for selection. Upon selection of the e-sign button 315, the information will be sent from the mobile device to the credit account provider. In some embodiments, it will be provided via an intermediary such as POS 230.

In one embodiment, when the e-sign button 315 is selected a timestamp will be added to the metadata.

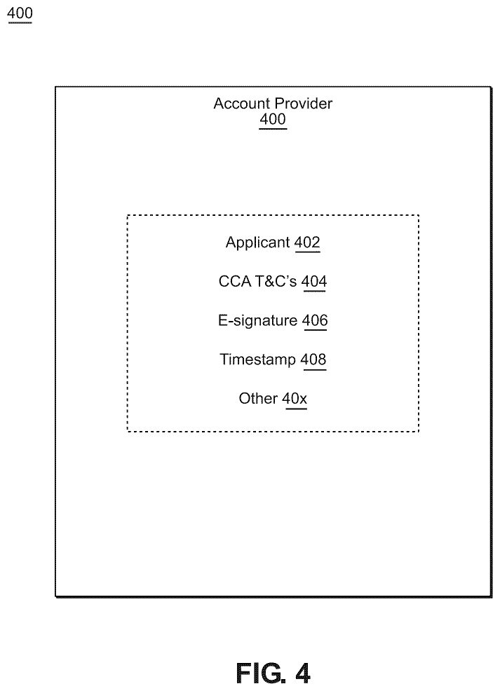

With reference now to FIG. 4, a block diagram of the content ultimately received by the credit account provider computer system 400 as part of the e-consent capture is shown in accordance with an embodiment.

In one embodiment, the received content includes applicant information 402, a copy of the provided CCA T&C's 404, the e-signature 406, a timestamp 408, and any other data 40x. In one embodiment, the other data 40x could include data such as imagery from imaging device 216c, location data (e.g., GPS, within transmission range of beacon 216b, POS 230, short-range device 216a, etc.), device ID, or the like.

In one embodiment, timestamp 408 will show the consumer received the CCA's prior to their first purchase and even before they created their account. In other words, the digital consent (e-signature 406) with timestamp 408 shows the digital consent was obtained prior to application process.

In one embodiment, some or all of the ID information 314 is used to perform a user look up.

In one embodiment, the user look-up is a database search such as described in detail in U.S. Pat. No. 11,468,508; the content of which is incorporated herein by reference in its entirety.

In one embodiment, the user look-up is a mobile aggregator search such as described in detail in U.S. Pat. No. 10,169,775; the content of which is incorporated herein by reference in its entirety.

In one embodiment, such as during implementation, testing, or the like, a paper application will be provided to the customer after the e-consent has been completed. In one embodiment, the result of the user-look up will be compared with paper applications obtained within the same time period to determine a correlation between customer e-consent applications to completed paper applications. The comparison will provide a resultant indicator of customer's who obtained the electronic consent before completing the application at a point of sale.

Thus, embodiments described herein provide a solution that allows a company to remove the paper application requirement. This alone will reduce or remove printing, distribution, and deployment costs which in some cases are on the range of 8-12 million dollars per year.

Embodiments disclosed herein also significantly reduce business waste by not only removing paper application from the POS but also providing the CCA in an electronic format such that a material change to a CCA will no longer cause a collection and destruction of existing printed media.

Embodiments disclosed herein also provide the ability to monitor the presentation of CCA's to the customer and electronically track CCA attribution at the store and even the associate level.

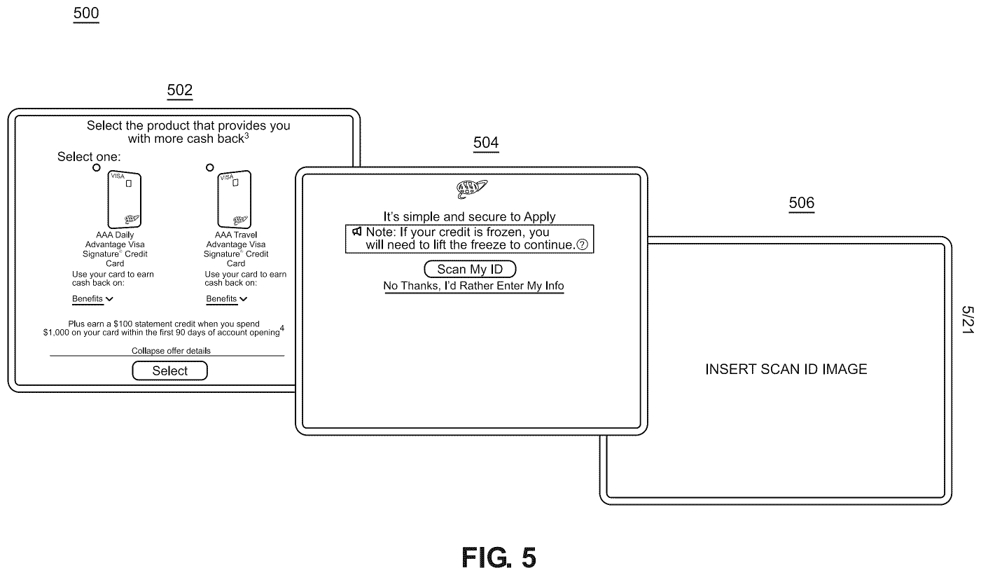

With reference now to FIG. 5, a schematic diagram 500 of a set of graphic user interfaces (GUIs) 502, 504 and 506 utilized in accordance with an embodiment of the present invention is provided. As will be discussed in detail below, various embodiments of the present invention provide an additional process and system for improving mobile credit acquisition.

As an overview, in various embodiments, as will be described herein, a mobile credit acquisition with form population that differs significantly from the conventional customer credit account application processes is disclosed. In conventional approaches, when filling out the forms to apply for credit, the customer must key in a significant amount of information such as name, address, device number, birthday, identification number, etc. Such conventional approaches are error prone, tedious, time-consuming, and often times a user will abandon the application process before it is completed.

In addition, because the scanning of the capturable code causes the text message to be addressed, any typo's that might occur during the user inputting the short code are removed. For example, if the offer requires a text to 74747, and the user types in a wrong number as the text address, e.g., 47474, 77447, etc., the user never actually responded to the offer and the opportunity would be missed. Similar mistakes could be made if an associate is providing the short code. They could provide a wrong short code, are misheard, etc. By having the capturable code cause the text message (or email message, the opening of an app, the downloading of an app, etc.) to be generated and addressed, any typographical mistake with respect to the short code is completely removed from the procedure.

Instead, the present embodiments, as will be described and explained below in detail, provide a previously unknown procedure for interacting with a capturable code (e.g., a 1D code, 2D code, 3D code, sound code, picture code, video code, etc.) with a camera, microphone, via near field communication (NFC), or other capture capability on the user's mobile device. The result of the user's mobile device interacting with a capturable code is the generation of a text message that is formatted and addressed (e.g., a text number or other short code) to deliver the text message to the credit account offeror. By having the capturable code automatically generate and format a text message, the user is saved the time required to open and address the text message.

Moreover, since the text message (or other electronic message) is formatted from instructions provided in the capturable code, the initial generated text message will include the information the capturable code requested. Such information could include a request for user ID information, a request for device ID information, a generation of metadata associated with the text message that includes device ID information, location information, user ID information, etc. As discussed below, the automatic generation of the text message from the scanning of the capturable code could include automatic insertion of one or more pieces of information, a request for authorization to send the email with the automatically inserted information, a request for manual input of one or more of the pieces of information, a combination of automatic and manually input information, etc.

Thus, the disclosed embodiments reduce clerical errors that could cause a non-response to an offer and further reduce the amount of data a customer has to key into their mobile device by formatting and addressing the text message, locating the customer's name, address and other personal information via automated searches, and prepopulating the application with the information found during the search. Thus, embodiments of the present invention provide a streamlined method for mobile credit acquisition which extends well beyond what was previously done by hand.

Importantly, the embodiments of the present invention, as will be described below, the various embodiments of the present invention do not merely implement conventional mobile credit acquisition processes on a computer. Instead, the various embodiments of the present invention provide a novel process for mobile credit acquisition with form population which is necessarily rooted in computer technology to overcome a problem specifically arising in the realm of digital customer key fatigue.

Moreover, the embodiments do not recite a mathematical algorithm; nor do they recite a fundamental economic or longstanding commercial practice. Instead, they address a business challenge that has been born in the Internet-centric environment in order to overcome numerous problems specifically arising in the realm of credit application and acceptance. In so doing, significant steps are removed from the customer's responsibility and the customer's time is saved.

Additionally, various aspects of a credit application system and methodology utilized in conjunction with the present embodiments are described in detail in: U.S. Pat. Nos. 10,169,775, 10,929,924, 11,163,943, 11,468,508, 11,488,194, 11,625,774, 11,645,697, 11,769,000, 12,051,085, U.S. Publication No. US 2017-0061511 A1, U.S. Publication No. US 2018-0053252 A1, U.S. Publication No. US 2020-0143465 A1, U.S. Publication No. US 2021-0019742 A1, U.S. Publication No. US 2020-0286168 A1, U.S. Publication No, US 2021-0174437 A1, and U.S. Publication No. US 2022-0414769 A1, each of which is incorporated herein by reference in its entirety.

With reference now to FIG. 5, often a customer (herein also referred to as a “user”), when visiting store or other establishment, may be interested in obtaining a credit card/credit account for that store. Some establishments, as described in detail in the above-referenced and herein incorporated US patents and patent applications, may present the user with, for example, a QR code which the user can scan to initiate a credit acquisition process. However, in some instances the user may not have their mobile device with them, or for other reasons, the user does not desire or understand how to utilize the provided approach to initiate the credit acquisition process. In various embodiments of the present invention, an employee of the establishment (herein also referred to as an “associate”) will be enabled to assist the user with the credit acquisition process.

As depicted in GUI 502, in one embodiment an associate device, such as but not limited to, a tablet, a mobile computing device, and the like, will enable the associate to display, for example, the various credit account options. The user can then choose the account which the user desires to apply for.

In one embodiment, as depicted in GUI 504, the associate will then allow the user to confirm the user's desire to apply for the selected credit account. It should be noted that in various embodiments of the present invention GUIs 502 and 504 are presented on the associate's device. In so doing, the process of applying for a credit account is “associate-assisted” thereby reducing any perceived burden on the user during the credit acquisition process. As shown in GUI 504, the user is then able to confirm, using the associate's device, that the user does, in fact, wish to proceed with the credit acquisition process. In the various embodiments of the present invention, the utilization of the present associate-assisted system and method both increases user participation with the credit acquisition process (as described in the above-referenced and herein incorporated US patents and patent applications), and, as will be described in further detail below, the various embodiments of the present invention help to prevent fraud by involving the associate, and the associate's device, in the credit acquisition process.

Referring still to FIG. 5, as shown at GUI 506, in the present embodiment, the associate is then prompted, via the associate's device to insert/scan (or otherwise capture) the user's identification. In various embodiments, the user's identification can be, for example, the user's driver's license, a military identification (ID) card, and the like. It should be noted that the embodiments of the present are well suited to use with various types of user identification and to various methodologies for capturing the user's identification. That is, the embodiments of the present invention are not limited solely to use with any single type of user identification. Further, the embodiments of the present invention are not limited solely to using any single means of capturing the user's identification.

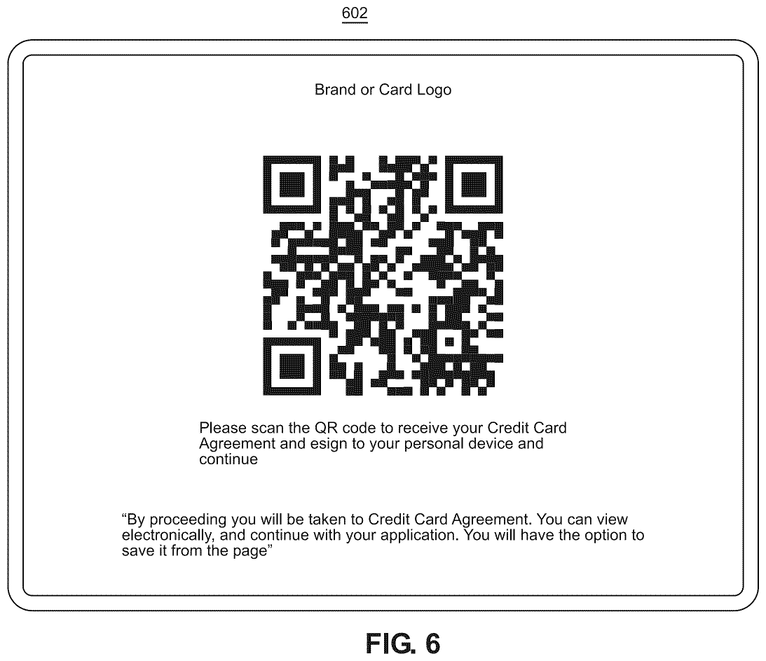

With reference next to GUI 602 of FIG. 6, in various embodiments, once the user's ID has been captured, a dynamic QR code, or similar data pertaining to the captured user's ID, is received on the associate device. It should be noted that in various embodiments, the dynamic QR code, or similar dynamic data pertaining to the captured user's ID will include and/or embed therein information which uniquely pertains to the user's captured ID (i.e., the data is herein referred to as “dynamic” in that the data uniquely pertains to the user whose ID was captured via the associate's device). As a result, the dynamic QR code, or similar data pertaining to the captured user's ID, as received on the associate's device, further enhances security of the present credit acquisition process by ensuring that the dynamic QR code, or similar data pertaining to the captured user's ID, only pertains to the user whose ID was just captured via the associate's device.

Once the dynamic QR code, or similar data pertaining to the captured user's ID is received at the associate's device, the associate will prompt the user to use their (i.e., the user's) phone, mobile device or other means, to scan or otherwise capture/enter the dynamic QR code, or similar data pertaining to the captured user's ID that is displayed on the associate's device. Once again, as illustrated by GUI 602 of FIG. 6, the various embodiments of the present invention, are “associate-assisted” thereby mitigating any potential perceived burden on the user and eliminating any possible user data entry errors. Furthermore, the embodiments of the present invention also reduce any possible confusion or difficulties for the user during the credit acquisition process.

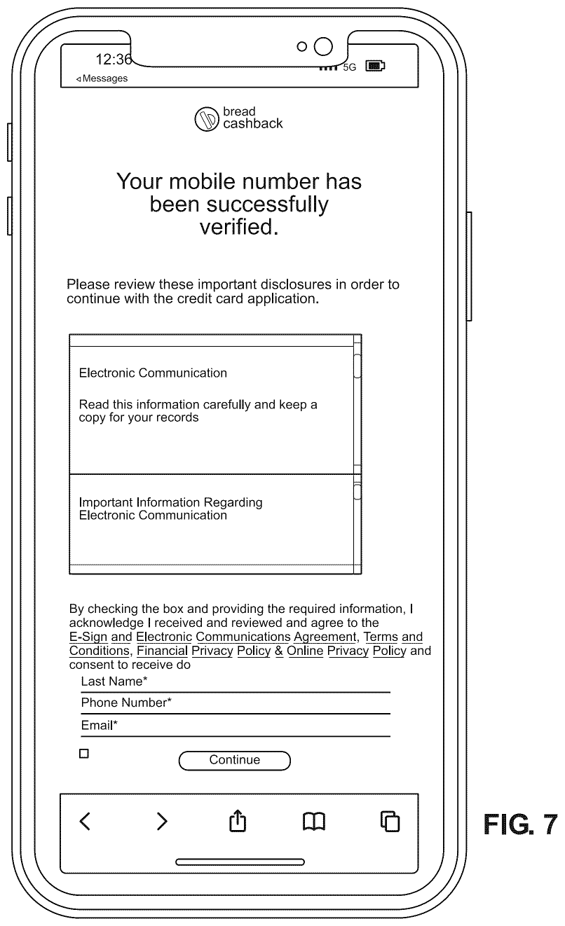

Referring now to FIG. 7, once the user has scanned/captured/entered the dynamic QR code, or similar dynamic data pertaining to the captured user's ID from the associate's device, the user is informed, via, for example, the user's device, that the user's mobile phone number has been verified. Again, it should be noted that the embodiments of the present invention are also well suited to verifying the identity of any other of the user's mobile devices, or other means which were used to scan or otherwise capture/enter the dynamic QR code, or similar data pertaining to the captured user's ID that was displayed on the associate's device as shown in 602 of FIG. 6.

With reference still to FIG. 7, as shown in GUI 702, in various embodiments of the present invention, the user's phone (or other device) will prompt the user to, for example, “Please review these important disclosures in order to continue with the card application”, or similar language. In various embodiments of the present invention, the user must “check a box” or otherwise indicate, on the user's device, that “By checking the box and providing the required information, I acknowledge I received and reviewed and agree to the E-sign and Electronic Communications Agreement, Terms and Conditions, Electronic Privacy Policy & Online Privacy Policy and consent to receiving data . . . .” It will be understood that in various embodiments of the present invention, the specific language and terms which the user must acknowledge, and for which the user must provide electronic consent, can vary as needed to comply with any local, state and/or federal regulations. Additionally, in various embodiments of the present invention, GUI 702 will also provide hyperlink(s) such that the user can readily access any necessary and required legal information.

Furthermore, in various embodiments of the present invention, GUI 702 will also inform a user that the user is able to email himself/herself a copy of the E-sign and Electronic Communications Agreement, Terms and Conditions, Electronic Privacy Policy & Online Privacy Policy, and the like. In so doing, embodiments of the present invention meet (and have proof) the legal requirement typically referred to as “Obtain and Retain”. That is, GUI 702, and the user's acceptance of the terms thereon, clearly indicate that the user has “Obtained” the necessary and required legal information. Moreover, by informing the user, in GUI 702, that the user is able to email himself/herself a copy of the necessary and required legal information, embodiments of the present invention also allow the user to “Retain” such necessary and required legal information. Also, in various embodiments of the present invention, at GUI 702, the user is able to “check a box” or otherwise indicate, on the user's device, that the user electronically consents to the necessary and required legal information without requiring that the user must first read all of the necessary and required legal information.

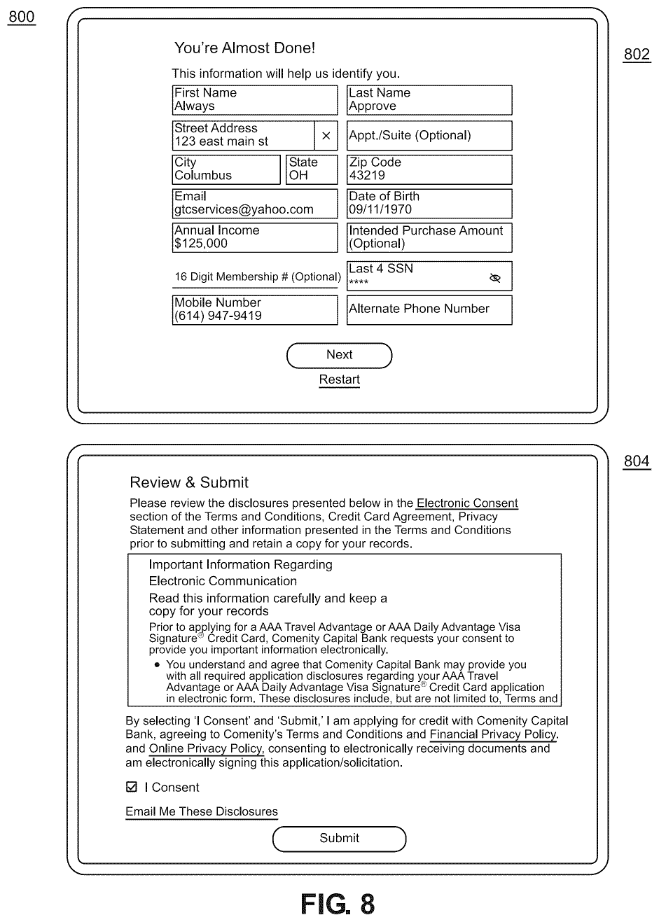

Referring now to FIG. 8 and the set 800 of GUIs, 802 and 804, once the user electronically consents to the necessary and required legal information (via GUI 702 of FIG. 7), the associate's device will display, for example, a pre-filled credit account application. In various embodiments, the pre-filled credit account application is created using the credit acquisition process (as described in the above-referenced and herein incorporated US patents and patent applications). In various embodiments of the present invention, the associate's device will not generate GUI 802 unless, and until, the user has electronically consented to the necessary and required legal information using GUI 702 of FIG. 7. In various embodiments of the present invention, the user will utilize GUI 802 on the associate's device to confirm that the information contained in the credit account application is accurate.

As shown in GUI 804, the user will once again use the associate's device to electronically consent to credit card agreement (CCA) including various terms and conditions (T&C's). Once again, it should be noted that in various embodiments of the present invention GUIs 802 and 804 are presented on the associate's device. In so doing, the process of applying for a credit account is “associate-assisted” thereby reducing any perceived burden on the user during the credit acquisition process. As mentioned above, in the various embodiments of the present invention, the utilization of the present associate-assisted system and method both increases user participation with the credit acquisition process and helps to prevent fraud by involving the associate, and the associate's device, in the credit acquisition process.

Moreover, in various embodiments of the present invention, GUI 804 of FIG. 8, similar to GUI 702 of FIG. 7, will inform the user that the user is able to email himself/herself a copy of the CCA. Once again, embodiments of the present invention meet (and establish an electronic record that) the legal requirement typically referred to as “Obtain and Retain” for the CCA has been met. That is, GUI 804, and the user's acceptance of the terms using the associate's device, clearly indicate that the user has “Obtained” the necessary and required CCA. Moreover, by informing the user, via GUI 804, that the user is able to email himself/herself a copy of the CCA, embodiments of the present invention also allow the user to “Retain” the CCA.

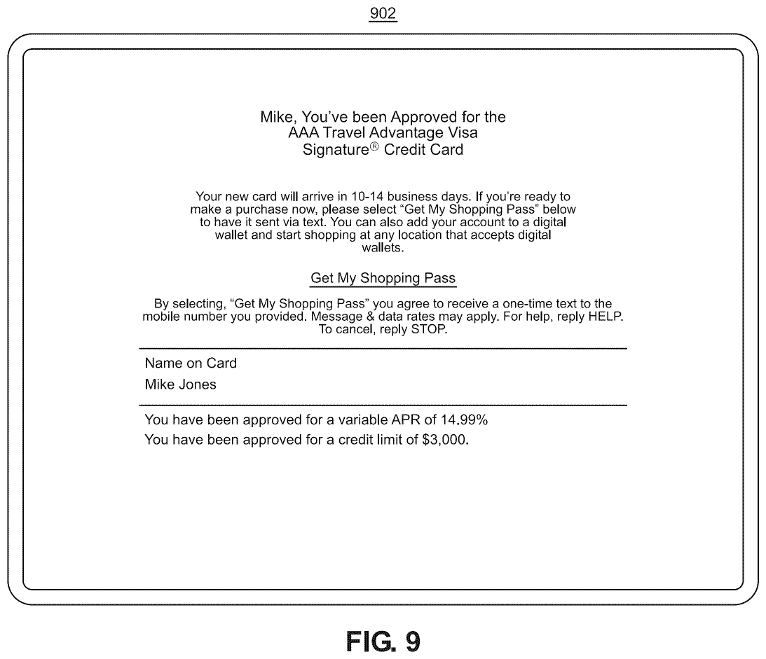

At GUI 902 of FIG. 9, when the user is approved for a credit account (e.g., a credit card account), the approval notification and corresponding information are provided on the associate's device. In accordance with the present embodiments, the user is now able to utilize their newly obtained credit card account in the same manner as described in the above-referenced and herein incorporated US patents and patent applications. It should again be stated that in various embodiments of the present invention, the GUIs of FIGS. 8 and 9 and the corresponding tasks associated therewith are implemented via the associate's device. Hence, the present associate-assisted process of applying for a credit account, once again, reduces any perceived burden on the user during the credit acquisition process. Further, the utilization of the present associate-assisted system and method both increases user compliance and helps to prevent fraud by involving the associate, and the associate's device, in the credit acquisition process.

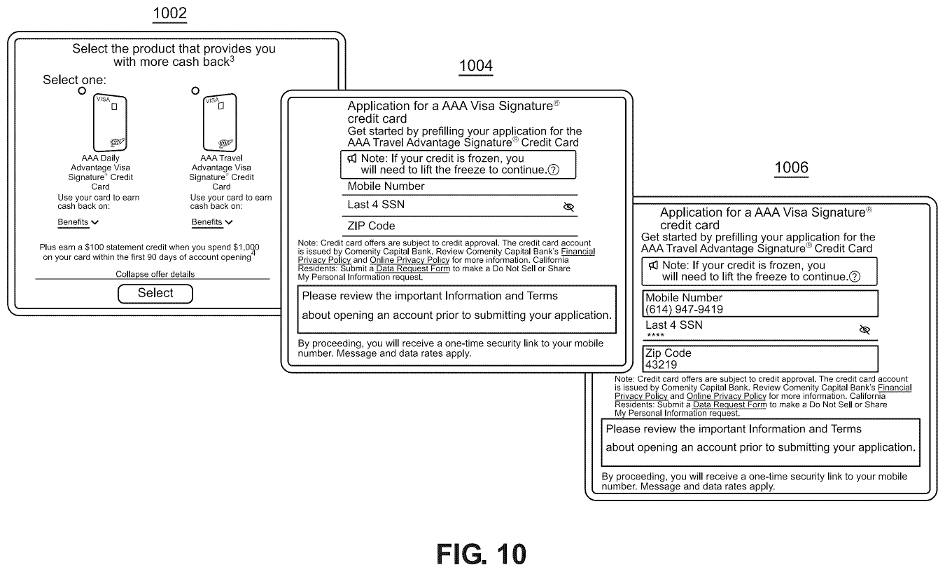

Referring now to FIG. 10, a set 1000 of GUIs 1002, 1004 and 1006 utilized in accordance with one embodiment of the present invention is provided. As depicted in GUI 1002, in one embodiment an associate device, such as but not limited to, a tablet, a mobile computing device, and the like, will enable the associate to display, for example, the various credit account options. The user can then choose the account which the user desires to apply for.

In one embodiment, as depicted in GUI 1004, the associate will then allow the user to confirm the user's desire to apply for the selected credit account. It should be noted that in various embodiments of the present invention GUIs 1002, 1004 and 1006 are presented on the associate's device. In so doing, the process of applying for a credit account is “associate-assisted” thereby reducing any perceived burden on the user during the credit acquisition process. As shown in GUI 1004, the user is then able to confirm, using the associate's device, that the user does, in fact, wish to receive rich communication services message in order to proceed with the credit acquisition process. In the various embodiments of the present invention, the utilization of the present associate-assisted system and method both increases user participation with the credit acquisition process (as described in the above-referenced and herein incorporated US patents and patent applications), and, as will be described in further detail below, the various embodiments of the present invention help to prevent fraud by involving the associate, and the associate's device, in the credit acquisition process.

Referring still to FIG. 10, as shown at GUI 1004, in the present embodiment, the associate is then prompted, via the associate's device to enter (or otherwise capture) the user's mobile device number. In various embodiments of the present invention, the user must “check a box” or otherwise indicate, on the user's device, that “By checking the box and providing the required information, I acknowledge I received and reviewed and agree to the E-sign and Electronic Communications Agreement, Terms and Conditions, Electronic Privacy Policy & Online Privacy Policy and consent to receiving data . . . .” It will be understood that in various embodiments of the present invention, the specific language and terms which the user must acknowledge to receive rich communication services (RCS) messages, and for which the user must provide electronic consent, can vary as needed to comply with any local, state and/or federal regulations. In various embodiments of the present invention, RCS messaging is well suited to use in geographic areas where, for example, mobile cell coverage is not particularly good and/or robust.

Furthermore, in various embodiments of the present invention, GUI 1004 will also inform a user that the user is able to email himself/herself a copy of the E-sign and Electronic Communications Agreement, Terms and Conditions, Electronic Privacy Policy & Online Privacy Policy, and the like. In so doing, embodiments of the present invention meet (and have proof) the legal requirement typically referred to as “Obtain and Retain”. That is, GUI 1004, and the user's acceptance of the terms thereon, clearly indicate that the user has “Obtained” the necessary and required legal information. Moreover, by informing the user, in GUI 1004, that the user is able to email himself/herself a copy of the necessary and required legal information, embodiments of the present invention also allow the user to “Retain” such necessary and required legal information. Also, in various embodiments of the present invention, at GUI 1004, the user is able to “check a box” or otherwise indicate, on the user's device, that the user electronically consents to the necessary and required legal information without requiring that the user must first read all of the necessary and required legal information.

In FIG. 10, in various embodiments of the present invention, GUI 1006 on the associate's device is utilized to prompt the user to, for example, “Please review these important disclosures in order to continue with the card application”, or similar language. In various embodiments of the present invention, the user must “check a box” or otherwise indicate, on the associate's device, that “By checking the box and providing the required information, I acknowledge I received and reviewed and agree to the E-sign and Electronic Communications Agreement, Terms and Conditions, Electronic Privacy Policy & Online Privacy Policy and consent to receiving data . . . .” It will be understood that in various embodiments of the present invention, the specific language and terms which the user must acknowledge, and for which the user must provide electronic consent, can vary as needed to comply with any local, state and/or federal regulations. Additionally, in various embodiments of the present invention, GUI 1006, like GUI 1004, will also provide hyperlink(s) such that the user can readily access any necessary and required legal information.

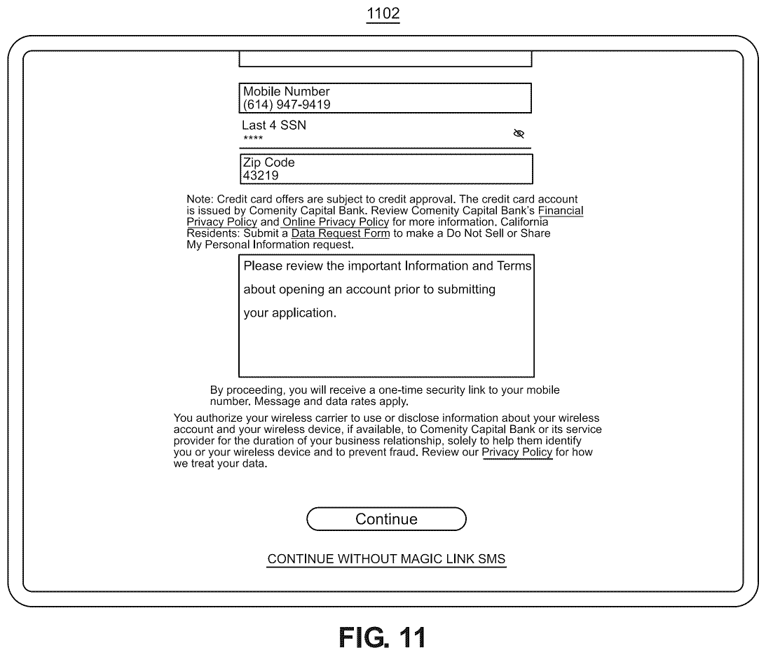

Furthermore, in various embodiments of the present invention, GUI 1006, like GUI 1004, will also inform a user that the user is able to email himself/herself a copy of the E-sign and Electronic Communications Agreement, Terms and Conditions, Electronic Privacy Policy & Online Privacy Policy, and the like. In so doing, embodiments of the present invention meet (and have proof) the legal requirement typically referred to as “Obtain and Retain”. That is, GUI 1006, and the user's acceptance of the terms thereon, clearly indicate that the user has “Obtained” the necessary and required legal information. Moreover, by informing the user, in GUI 1006, that the user is able to email himself/herself a copy of the necessary and required legal information, embodiments of the present invention also allow the user to “Retain” such necessary and required legal information. It should be noted that GUI 1102 of FIG. 11 provides an additional depiction of information provided on the associate's device related to obtaining the user's electronic consent as discussed above.

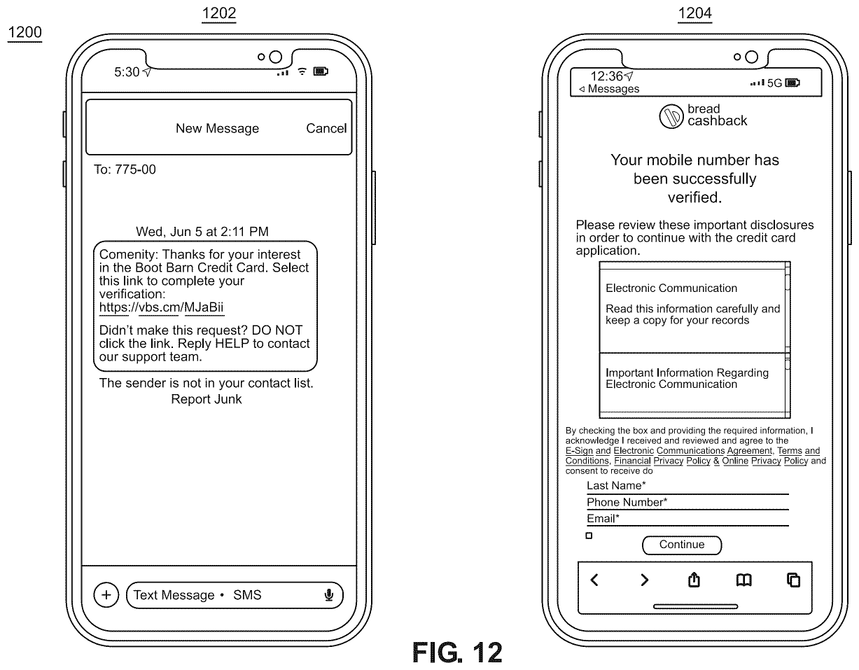

Referring now to FIG. 12 and the set 1200 of GUIs 1202 and 1204, once the user electronically consents to the necessary and required legal information (via GUIs 1002, 1004 1006 of FIG. 10 and GUI 1102 of FIG. 11), the user's device will receive and display the RCS message. In one embodiment of the present invention, the RCS message received on the user's device will contain, for example, a uniform resource locator (URL) which the user can select to initiate the credit application process as described in the above-referenced and herein incorporated US patents and patent applications. Moreover, in various embodiments of the present invention, the URL contained within the RCS message received on the user's device is a “light” or short URL which is well suited to use with, and which can be readily transmitted using, an RCS message.

As shown in GUI 1204, upon selecting the URL of GUI 1202, the user will receive on the user's device, for example, a one-time passcode (OTP) to be used by the associate as will be discussed below. The user's device will also inform the user that, for example, “Your mobile number has been successfully verified”. It should be understood that the embodiments of the present invention are well suited to verifying the user's mobile number using any of a myriad of verification systems and methodologies, many of which are described in detail in the above-referenced and herein incorporated US patents and patent applications.

Referring still to GUI 1204 of FIG. 12, the user's mobile device will prompt the user to, for example, “Please review these important disclosures in order to continue with the card application”, or similar language. In various embodiments of the present invention, the user must “check a box” or otherwise indicate, on the user's device, that “By checking the box and providing the required information, I acknowledge I received and reviewed and agree to the E-sign and Electronic Communications Agreement, Terms and Conditions, Electronic Privacy Policy & Online Privacy Policy and consent to receiving data . . . .” It will be understood that in various embodiments of the present invention, the specific language and terms which the user must acknowledge, and for which the user must provide electronic consent, can vary as needed to comply with any local, state and/or federal regulations. Additionally, in various embodiments of the present invention, GUI 1204 will also provide hyperlink(s) such that the user can readily access any necessary and required legal information.

Furthermore, in various embodiments of the present invention, GUI 1204 will also inform a user that the user is able to email himself/herself a copy of the E-sign and Electronic Communications Agreement, Terms and Conditions, Electronic Privacy Policy & Online Privacy Policy, and the like. In so doing, embodiments of the present invention meet (and have proof) the legal requirement typically referred to as “Obtain and Retain”. That is, GUI 1204, and the user's acceptance of the terms thereon, clearly indicate that the user has “Obtained” the necessary and required legal information. Moreover, by informing the user, in GUI 1204, that the user is able to email himself/herself a copy of the necessary and required legal information, embodiments of the present invention also allow the user to “Retain” such necessary and required legal information. Also, in various embodiments of the present invention, at GUI 1204, the user is able to “check a box” or otherwise indicate, on the user's device, that the user electronically consents to the necessary and required legal information without requiring that the user must first read all of the necessary and required legal information.

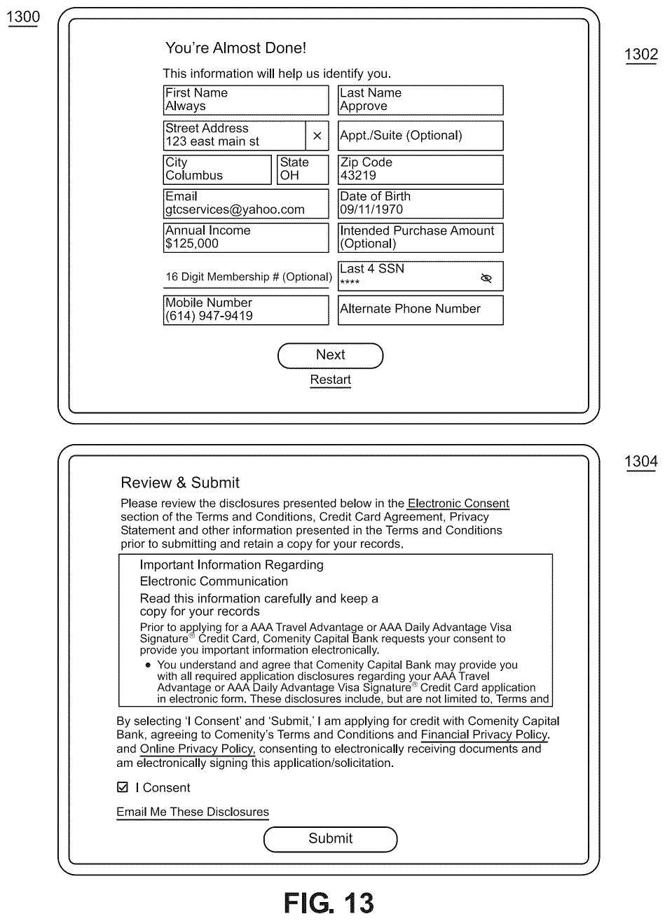

Referring now to FIG. 13 and the set 1300 of GUIs, 1302 and 1304, once the user electronically consents to the necessary and required legal information (via GUI 1204 of FIG. 12), and by providing the OTP to the associate, the associate's device will display, for example, a pre-filled credit account application. In various embodiments, the pre-filled credit account application is created using the credit acquisition process (as described in the above-referenced and herein incorporated US patents and patent applications). In various embodiments of the present invention, the associate's device will not generate GUI 1302 unless, and until, the user has electronically consented to the necessary and required legal information using GUI 1204 of FIG. 12 and the associate has received the OTP. In various embodiments of the present invention, the user will now utilize GUI 1302 on the associate's device to confirm that the information contained in the credit account application is accurate.

As shown in GUI 1304, the user will once again use the associate's device to electronically consent to credit card agreement (CCA) including various terms and conditions (T&C's). Once again, it should be noted that in various embodiments of the present invention GUIs 1302 and 1304 are presented on the associate's device. In so doing, the process of applying for a credit account is “associate-assisted” thereby reducing any perceived burden on the user during the credit acquisition process. As mentioned above, in the various embodiments of the present invention, the utilization of the present associate-assisted system and method both increases user participation/compliance with the credit acquisition process and helps to prevent fraud by involving the associate, and the associate's device, in the credit acquisition process.

Moreover, in various embodiments of the present invention, GUI 1304 of FIG. 13, similar to GUI 1204 of FIG. 12, will inform the user that the user is able to email himself/herself a copy of the CCA. Once again, embodiments of the present invention meet (and establish an electronic record that) the legal requirement typically referred to as “Obtain and Retain” for the CCA has been met. That is, GUI 1304, and the user's acceptance of the terms using the associate's device, clearly indicate that the user has “Obtained” the necessary and required CCA. Moreover, by informing the user, via GUI 1304, that the user is able to email himself/herself a copy of the CCA, embodiments of the present invention also allow the user to “Retain” the CCA.

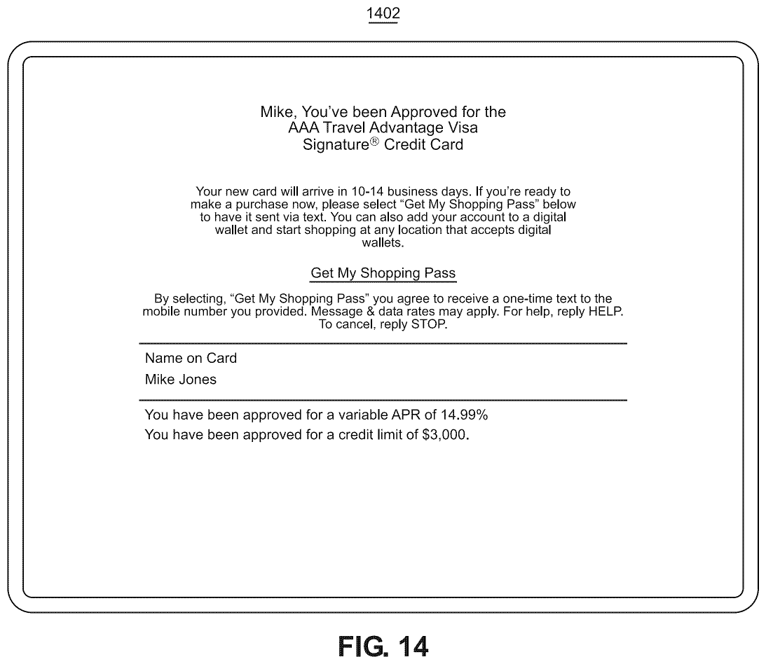

At GUI 1402 of FIG. 14, when the user is approved for a credit account (e.g., a credit card account), the approval notification and corresponding information are provided on the associate's device. In accordance with the present embodiments, the user is now able to utilize their newly obtained credit card account in the same manner as described in the above-referenced and herein incorporated US patents and patent applications. It should again be stated that in various embodiments of the present invention, the GUIs of FIGS. 13 and 14 and the corresponding tasks associated therewith are implemented via the associate's device. Hence, the present associate-assisted process of applying for a credit account, once again, reduces any perceived burden on the user during the credit acquisition process. Further, the utilization of the present associate-assisted system and method both increases user compliance and helps to prevent fraud by involving the associate, and the associate's device, in the credit acquisition process.

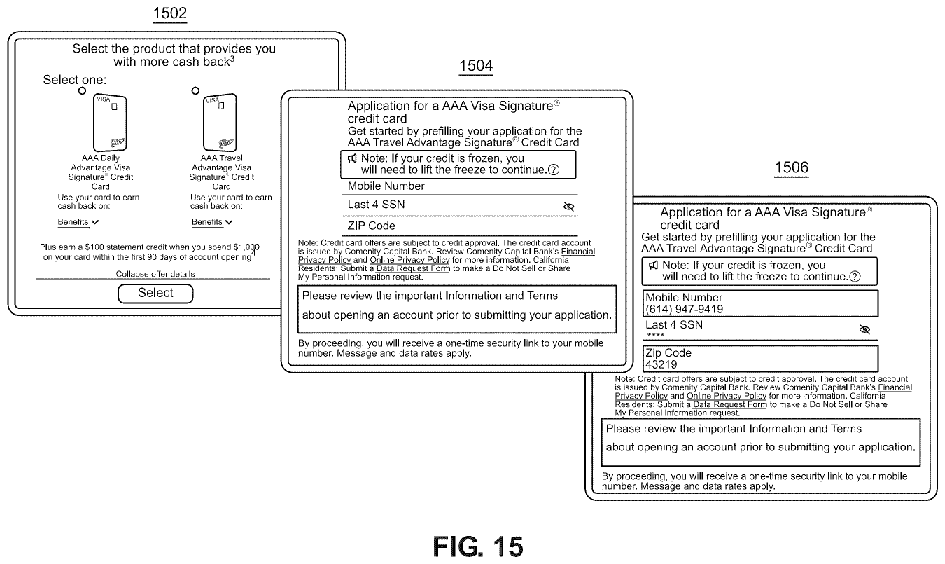

Referring now to FIG. 15, a set 1500 of GUIs 1502, 1504 and 1506 utilized in accordance with one embodiment of the present invention is provided. As depicted in GUI 1502, in one embodiment an associate device, such as but not limited to, a tablet, a mobile computing device, and the like, will enable the associate to display, for example, the various credit account options. The user can then choose the account which the user desires to apply for.

In one embodiment, as depicted in GUI 1504, the associate will then allow the user to confirm the user's desire to apply for the selected credit account. It should be noted that in various embodiments of the present invention GUIs 1502, 1504 and 1506 are presented on the associate's device. In so doing, the process of applying for a credit account is “associate-assisted” thereby reducing any perceived burden on the user during the credit acquisition process. As shown in GUI 1504, the user is then able to confirm, using the associate's device, that the user does, in fact, wish to receive rich communication services message in order to proceed with the credit acquisition process. In the various embodiments of the present invention, the utilization of the present associate-assisted system and method both increases user participation with the credit acquisition process (as described in the above-referenced and herein incorporated US patents and patent applications), and, as will be described in further detail below, the various embodiments of the present invention help to prevent fraud by involving the associate, and the associate's device, in the credit acquisition process.

Referring still to FIG. 15, as shown at GUI 1504, in the present embodiment, the associate is then prompted, via the associate's device to enter (or otherwise capture) the user's mobile device number. In various embodiments of the present invention, the user must “check a box” or otherwise indicate, on the user's device, that “By checking the box and providing the required information, I acknowledge I received and reviewed and agree to the E-sign and Electronic Communications Agreement, Terms and Conditions, Electronic Privacy Policy & Online Privacy Policy and consent to receiving data . . . .” It will be understood that in various embodiments of the present invention, the specific language and terms which the user must acknowledge to receive short message service (SMS) messages, and for which the user must provide electronic consent, can vary as needed to comply with any local, state and/or federal regulations. In various embodiments of the present invention, SMS messaging is well suited to use in geographic areas where, for example, mobile cell coverage strong and/or robust.

Importantly, various embodiments of the present invention as are described in conjunction with FIGS. 15-19, are well suited to using device verification (not merely “possession” verification) for the user's mobile device. In various embodiments, the device verification is achieved using any of a myriad of Digital Identity Verification and Fraud Prevention systems and methodologies. It should be understood that such Digital Identity Verification and Fraud Prevention systems and methodologies are sometimes also referred to KYC/KYB (Know Your Customer/Know Your Business) systems. KYC systems focus on verifying the identity of individual customers by collecting and verifying personal information such as, for example, the individual customer's: name; date of birth; address; and the individual's government-issued identification.

Furthermore, in various embodiments of the present invention, GUI 1504 will also inform a user that the user is able to email himself/herself a copy of the E-sign and Electronic Communications Agreement, Terms and Conditions, Electronic Privacy Policy & Online Privacy Policy, and the like. In so doing, embodiments of the present invention meet (and have proof) the legal requirement typically referred to as “Obtain and Retain”. That is, GUI 1504, and the user's acceptance of the terms thereon, clearly indicate that the user has “Obtained” the necessary and required legal information. Moreover, by informing the user, in GUI 1504, that the user is able to email himself/herself a copy of the necessary and required legal information, embodiments of the present invention also allow the user to “Retain” such necessary and required legal information. Also, in various embodiments of the present invention, at GUI 1504, the user is able to “check a box” or otherwise indicate, on the user's device, that the user electronically consents to the necessary and required legal information without requiring that the user must first read all of the necessary and required legal information.

In FIG. 15, in various embodiments of the present invention, GUI 1506 on the associate's device is utilized to prompt the user to, for example, “Please review these important disclosures in order to continue with the card application”, or similar language. In various embodiments of the present invention, the user must “check a box” or otherwise indicate, on the associate's device, that “By checking the box and providing the required information, I acknowledge I received and reviewed and agree to the E-sign and Electronic Communications Agreement, Terms and Conditions, Electronic Privacy Policy & Online Privacy Policy and consent to receiving data . . . .” It will be understood that in various embodiments of the present invention, the specific language and terms which the user must acknowledge, and for which the user must provide electronic consent, can vary as needed to comply with any local, state and/or federal regulations. Additionally, in various embodiments of the present invention, GUI 1506, like GUI 1504, will also provide hyperlink(s) such that the user can readily access any necessary and required legal information.

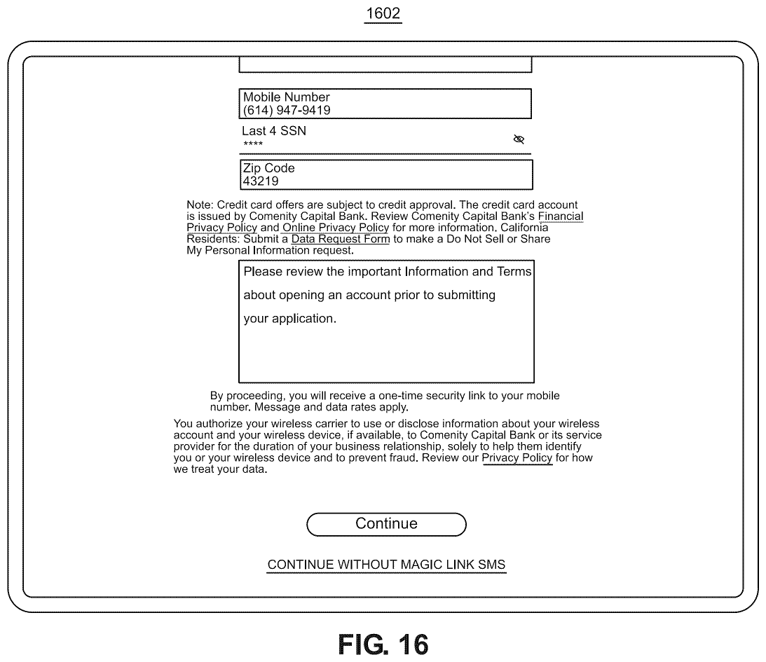

Furthermore, in various embodiments of the present invention, GUI 1506, like GUI 1504, will also inform a user that the user is able to email himself/herself a copy of the E-sign and Electronic Communications Agreement, Terms and Conditions, Electronic Privacy Policy & Online Privacy Policy, and the like. In so doing, embodiments of the present invention meet (and have proof) the legal requirement typically referred to as “Obtain and Retain”. That is, GUI 1506, and the user's acceptance of the terms thereon, clearly indicate that the user has “Obtained” the necessary and required legal information. Moreover, by informing the user, in GUI 1506, that the user is able to email himself/herself a copy of the necessary and required legal information, embodiments of the present invention also allow the user to “Retain” such necessary and required legal information. It should be noted that GUI 1602 of FIG. 16 provides an additional depiction of information provided on the associate's device related to obtaining the user's electronic consent as discussed above.

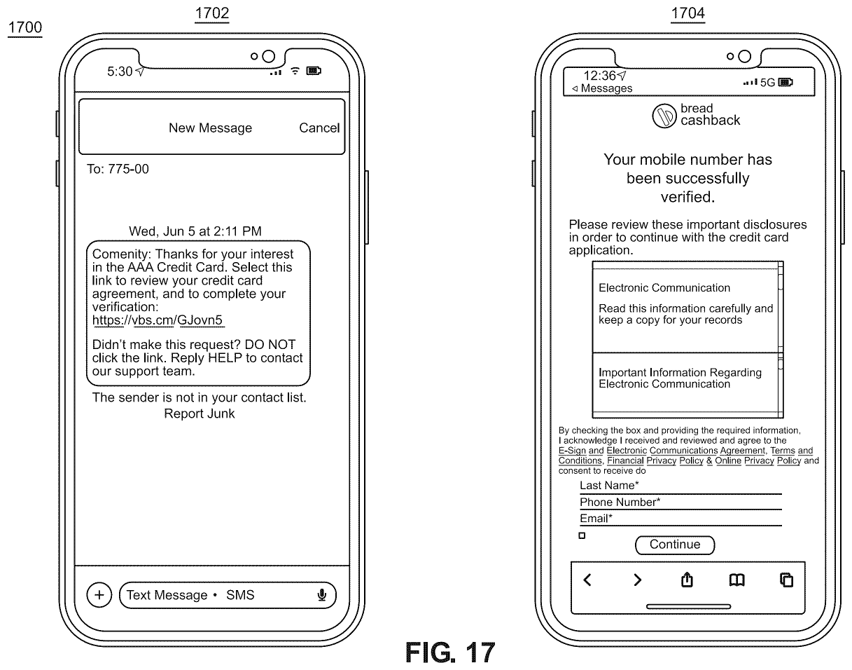

Referring now to FIG. 17 and the set 1700 of GUIs 1702 and 1704, once the user electronically consents to the necessary and required legal information (via GUIs 1502, 1504 1506 of FIG. 15 and GUI 1602 of FIG. 16), the user's device will receive and display the SMS message. In one embodiment of the present invention, the SMS message received on the user's device will contain, for example, a uniform resource locator (URL) which the user can select to initiate the credit application process as described in the above-referenced and herein incorporated US patents and patent applications.

As shown in GUI 1704, upon selecting the URL of GUI 1702, the user will receive on the user's device, for example, a message informing the user that, for example, “Your mobile number has been successfully verified”. It should be understood that the embodiments of the present invention are well suited to verifying the user's mobile number (or obtaining device verification) using any of a myriad of verification systems and methodologies, many of which are described in detail in the above-referenced and herein incorporated US patents and patent applications.

Referring still to GUI 1704 of FIG. 17, the user's mobile device will prompt the user to, for example, “Please review these important disclosures in order to continue with the card application”, or similar language. In various embodiments of the present invention, the user must “check a box” or otherwise indicate, on the user's device, that “By checking the box and providing the required information, I acknowledge I received and reviewed and agree to the E-sign and Electronic Communications Agreement, Terms and Conditions, Electronic Privacy Policy & Online Privacy Policy and consent to receiving data . . . .” It will be understood that in various embodiments of the present invention, the specific language and terms which the user must acknowledge, and for which the user must provide electronic consent, can vary as needed to comply with any local, state and/or federal regulations. Additionally, in various embodiments of the present invention, GUI 1704 will also provide hyperlink(s) such that the user can readily access any necessary and required legal information.

Furthermore, in various embodiments of the present invention, GUI 1704 will also inform a user that the user is able to email himself/herself a copy of the E-sign and Electronic Communications Agreement, Terms and Conditions, Electronic Privacy Policy & Online Privacy Policy, and the like. In so doing, embodiments of the present invention meet (and have proof) the legal requirement typically referred to as “Obtain and Retain”. That is, GUI 1704, and the user's acceptance of the terms thereon, clearly indicate that the user has “Obtained” the necessary and required legal information. Moreover, by informing the user, in GUI 1704, that the user is able to email himself/herself a copy of the necessary and required legal information, embodiments of the present invention also allow the user to “Retain” such necessary and required legal information. Also, in various embodiments of the present invention, at GUI 1704, the user is able to “check a box” or otherwise indicate, on the user's device, that the user electronically consents to the necessary and required legal information without requiring that the user must first read all of the necessary and required legal information.

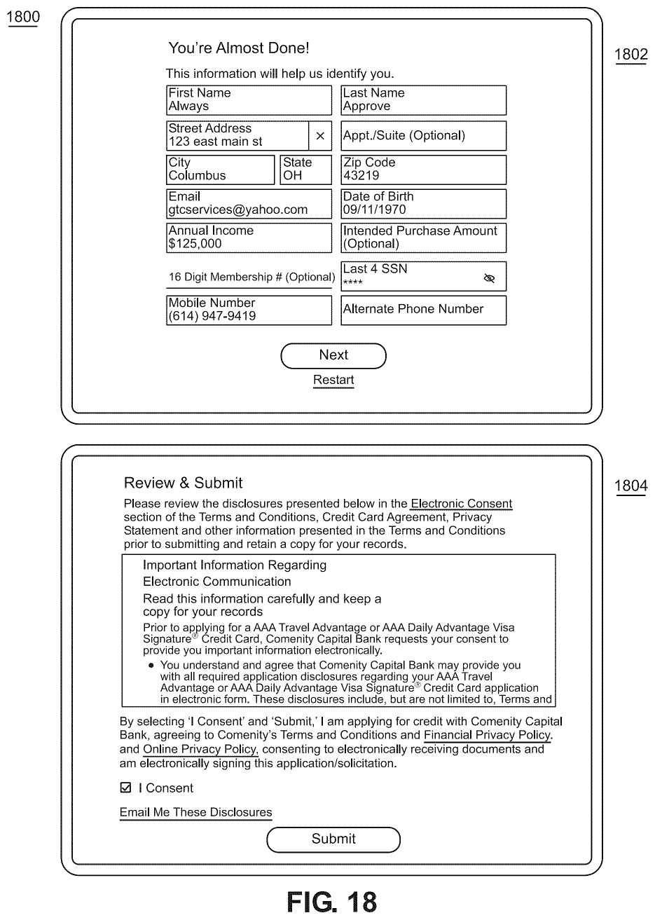

Referring now to FIG. 18 and the set 1800 of GUIs, 1802 and 1804, once the user electronically consents to the necessary and required legal information (via GUI 1704 of FIG. 17), the associate's device will display, for example, a pre-filled credit account application. In various embodiments, the pre-filled credit account application is created using the credit acquisition process (as described in the above-referenced and herein incorporated US patents and patent applications). In various embodiments of the present invention, the associate's device will not generate GUI 1802 unless, and until, the user has electronically consented to the necessary and required legal information using GUI 1704 of FIG. 17 and the user's device has been verified. In various embodiments of the present invention, the user will now utilize GUI 1802 on the associate's device to confirm that the information contained in the credit account application is accurate.

As shown in GUI 1804, the user will once again use the associate's device to electronically consent to credit card agreement (CCA) including various terms and conditions (T&C's). Once again, it should be noted that in various embodiments of the present invention GUIs 1802 and 1804 are presented on the associate's device. In so doing, the process of applying for a credit account is “associate-assisted” thereby reducing any perceived burden on the user during the credit acquisition process. As mentioned above, in the various embodiments of the present invention, the utilization of the present associate-assisted system and method both increases user participation/compliance with the credit acquisition process and helps to prevent fraud by involving the associate, and the associate's device, in the credit acquisition process.

Moreover, in various embodiments of the present invention, GUI 1804 of FIG. 18, similar to GUI 1704 of FIG. 17, will inform the user that the user is able to email himself/herself a copy of the CCA. Once again, embodiments of the present invention meet (and establish an electronic record that) the legal requirement typically referred to as “Obtain and Retain” for the CCA has been met. That is, GUI 1804, and the user's acceptance of the terms using the associate's device, clearly indicate that the user has “Obtained” the necessary and required CCA. Moreover, by informing the user, via GUI 1804, that the user is able to email himself/herself a copy of the CCA, embodiments of the present invention also allow the user to “Retain” the CCA.

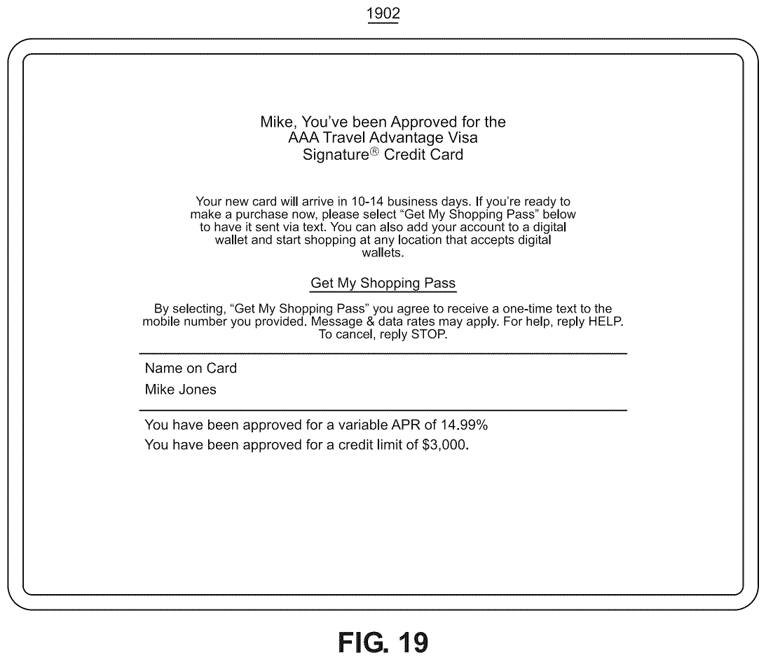

At GUI 1902 of FIG. 19, when the user is approved for a credit account (e.g., a credit card account), the approval notification and corresponding information are provided on the associate's device. In accordance with the present embodiments, the user is now able to utilize their newly obtained credit card account in the same manner as described in the above-referenced and herein incorporated US patents and patent applications. It should again be stated that in various embodiments of the present invention, the GUIs of FIGS. 18 and 19 and the corresponding tasks associated therewith are implemented via the associate's device. Hence, the present associate-assisted process of applying for a credit account, once again, reduces any perceived burden on the user during the credit acquisition process. Further, the utilization of the present associate-assisted system and method both increases user compliance and helps to prevent fraud by involving the associate, and the associate's device, in the credit acquisition process.

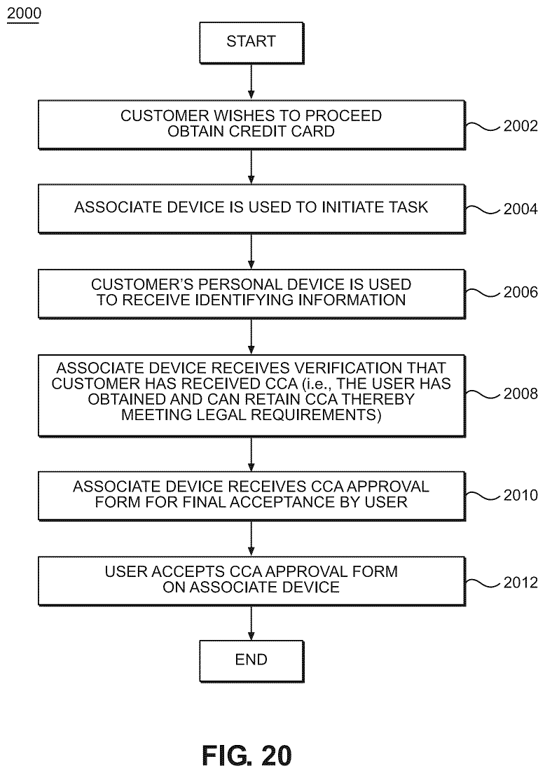

With reference next to FIG. 20, a flow chart 2000 is provided which summarizes actions of the various embodiments of the present invention which are described in great detail above.

At 2002, a user/customer wishes to proceed with obtaining a credit card.

At 2004, an associate device is used to initiate the task of obtaining a credit card for the user.

At 2006, the customer's/user's personal device is used to receive identifying information.

At 2008, the associate's device receives verification that customer has received the necessary CCA (i.e., the user has obtained and can retain CCA, thereby meeting legal requirements).

At 2010, the associate's device receives a CCA approval form for final acceptance by the user.

At 2012, the user accepts the CCA approval form using the associate's device.

### Example Computer System

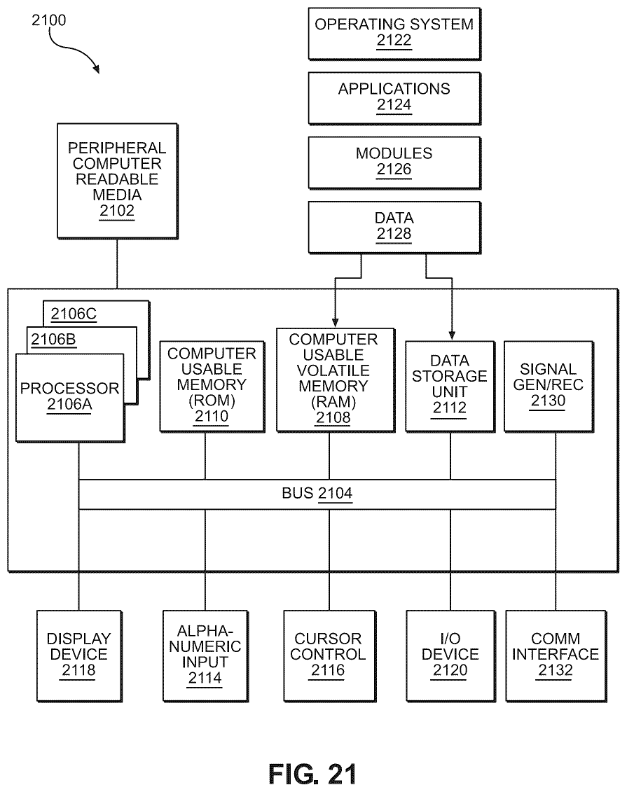

With reference now to FIG. 21, portions of the technology for providing a communication composed of computer-readable and computer-executable instructions that reside, for example, in non-transitory computer-readable medium (or storage media, etc.) of a computer system. FIG. 21 illustrates one example of a type of computer that can be used to implement embodiments of the present technology. FIG. 21 represents a system or components that may be used in conjunction with aspects of the present technology. In one embodiment, some or all of the components described herein may be combined with some or all of the components of FIG. 21 to practice the present technology.

FIG. 21 illustrates an example computer system 2100 used in accordance with embodiments of the present technology. It is appreciated that computer system 2100 of FIG. 21 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like with little modification. As shown in FIG. 21, computer system 2100 of FIG. 21 is well adapted to having peripheral computer readable media 2102 such as, for example, a disk, a compact disc, a flash drive, and the like coupled thereto.

Computer system 2100 of FIG. 21 includes an address/data/control bus 2104 for communicating information, and a processor 2106A coupled to bus 2104 for processing information and instructions. As depicted in FIG. 21, computer system 2100 is also well suited to a multi-processor environment in which a plurality of processors 2106A, 2106B, and 2106C are present. Conversely, computer system 2100 is also well suited to having a single processor such as, for example, processor 2106A. Processors 2106A, 2106B, and 2106C may be any of various types of microprocessors. Computer system 2100 also includes data storage features such as a computer usable volatile memory 2108, e.g., random access memory (RAM), coupled to bus 2104 for storing information and instructions for processors 2106A, 2106B, and 2106C.

Computer system 2100 also includes computer usable non-volatile memory 2110, e.g., read only memory (ROM), coupled to bus 2104 for storing static information and instructions for processors 2106A, 2106B, and 2106C. Also present in computer system 2100 is a data storage unit 2112 (e.g., a magnetic disk drive, optical disk drive, solid state drive (SSD), and the like) coupled to bus 2104 for storing information and instructions. Computer system 2100 also can optionally include an alpha-numeric input device 2114 including alphanumeric and function keys coupled to bus 2104 for communicating information and command selections to processor 2106A or processors 2106A, 2106B, and 2106C. Computer system 2100 also can optionally include a cursor control device 2116 coupled to bus 2104 for communicating user input information and command selections to processor 2106A or processors 2106A, 2106B, and 2106C. Cursor control device may be a touch sensor, gesture recognition device, and the like. Computer system 2100 of the present embodiment can optionally include a display device 2118 coupled to bus 2104 for displaying information.

Referring still to FIG. 21, display device 2118 of FIG. 21 may be a liquid crystal device, cathode ray tube, OLED, plasma display device or other display device suitable for creating graphic images and alpha-numeric characters recognizable to a user. Cursor control device 2116 allows the computer user to dynamically signal the movement of a visible symbol (cursor) on a display screen of display device 2118. Many implementations of cursor control device 2116 are known in the art including a trackball, mouse, touch pad, joystick, non-contact input, gesture recognition, voice commands, bio recognition, and the like. In addition, special keys on alpha-numeric input device 2114 capable of signaling movement of a given direction or manner of displacement. Alternatively, it will be appreciated that a cursor can be directed and/or activated via input from alpha-numeric input device 2114 using special keys and key sequence commands.

Computer system 2100 is also well suited to having a cursor directed by other means such as, for example, voice commands. Computer system 2100 also includes an I/O device 2120 for coupling computer system 2100 with external entities. For example, in one embodiment, I/O device 2120 is a modem for enabling wired or wireless communications between computer system 2100 and an external network such as, but not limited to, the Internet or intranet. A more detailed discussion of the present technology is found below.

Referring still to FIG. 21, various other components are depicted for computer system 2100. Specifically, when present, an operating system 2122, applications 2124, modules 2126, and data 2128 are shown as typically residing in one or some combination of computer usable volatile memory 2108, e.g. random-access memory (RAM), and data storage unit 2112. However, it is appreciated that in some embodiments, operating system 2122 may be stored in other locations such as on a network or on a flash drive; and that further, operating system 2122 may be accessed from a remote location via, for example, a coupling to the internet. In one embodiment, the present technology, for example, is stored as an application 2124 or module 2126 in memory locations within RAM 2108 and memory areas within data storage unit 2112. The present technology may be applied to one or more elements of described computer system 2100.

Computer system 2100 also includes one or more signal generating and receiving device(s) 2130 coupled with bus 2104 for enabling computer system 2100 to interface with other electronic devices and computer systems. Signal generating and receiving device(s) 2130 of the present embodiment may include wired serial adaptors, modems, and network adaptors, wireless modems, and wireless network adaptors, and other such communication technology. The signal generating and receiving device(s) 2130 may work in conjunction with one (or more) communication interface 2132 for coupling information to and/or from computer system 2100. Communication interface 2132 may include a serial port, parallel port, Universal Serial Bus (USB), Ethernet port, Bluetooth, thunderbolt, near field communications port, Wi-Fi, Cellular modem, or other input/output interface. Communication interface 2132 may physically, electrically, optically, or wirelessly (e.g., via radio frequency) couple computer system 2100 with another device, such as a mobile phone, radio, or computer system.

Computer system 2100 is only one example of a suitable computing environment and is not intended to suggest any limitation as to the scope of use or functionality of the present technology. Neither should the computing environment be interpreted as having any dependency or requirement relating to any one or combination of components illustrated in the example computer system 2100.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. An associate-assisted method for a credit acquisition process, said method comprising:
an associate assists a user with interacting with an electronic credit application;
verifying the user or a device of the user:
a selectable consent capability;
a credit account agreement including the terms and conditions;
an information request; and
an e-sign button;
completing said information request to complete said electronic message and selecting said e-sign button using a device of said associate;
a user receiving assistance with a credit account application for a credit account from a store associate, wherein said store associate presents, to said user, options for said credit account application via an associate device;
selecting said user's selected option for said credit account application via said associate device;
capturing, via said associate device, said user's identification;
receiving data uniquely pertaining to said user at said associate device;
prompting said user to utilize a user's device to capture, from said associate device, said data uniquely pertaining to said user and transmit said sad data uniquely pertaining to said user from said user's device to a party handling said credit account application, and provided said user's device is verified by said party handling said credit account application, informing said user that said user's device is verified;
requesting said user, via said user's device, to electronically consent to terms of said credit account application;
receiving, at said associate device, a pre-filled version of said credit account application;
utilizing said associate device to have said user electronically consent to a credit card agreement corresponding to said credit account; and
receiving, at said associate device, approval/denial information pertaining to said credit account application of said user.

2. The associate-assisted method for a credit acquisition process of claim 1, wherein said associate device is selected from the group consisting of: a tablet, a mobile computing device, and the like.

3. The associate-assisted method for a credit acquisition process of claim 1, wherein said user's identification is selected from the group consisting of: a driver's license of said user, a military identification of said user, and the like.

4. The associate-assisted method for a credit acquisition process of claim 1, wherein said capturing, via said associate device, said user's identification further is selected from the group consisting of: inserting said user's identification into said associate device, scanning said user's identification using said associate device, and the like.

5. The associate-assisted method for a credit acquisition process of claim 1, wherein said data uniquely pertaining to said user is a quick response (QR) code having said data uniquely pertaining to said user included/embedded therein.

6. The associate-assisted method for a credit acquisition process of claim 1, wherein said requesting said user, via said user's device, to consent to said terms of said credit account application further comprises:
requiring said user to comply with obtain and retain requirements for said credit account application.

7. The associate-assisted method for a credit acquisition process of claim 1, wherein said utilizing said associate device to have said user electronically consent to a credit card agreement corresponding to said credit account further comprises:
utilizing said associate device to have said user confirm that information contained in said pre-filled version of said credit account application is accurate.

8. The associate-assisted method for a credit acquisition process of claim 1, further comprising:
provided said user is approved for said credit account, receiving an approval notification at said associate device.

9. An associate-assisted method for a credit acquisition process, said method comprising:
a user receiving assistance with a credit account application for a credit account from a store associate, wherein said store associate presents, to said user, options for said credit account application via an associate device;
selecting said user's selected option for said credit account application via said associate device;
capturing, via said associate device, mobile device number corresponding to said user's mobile device;
receiving, via said associate device, consent from said user to receive data on said user's mobile device from a party handling said credit account application;
receiving, at said user's mobile device, data corresponding to said credit account application;
requesting said user, via said user's mobile device, to electronically consent to terms of said credit account application;
receiving, at said associate device, a pre-filled version of said credit account application;
utilizing said associate device to have said user electronically consent to a credit card agreement corresponding to said credit account; and
receiving, at said associate device, approval/denial information pertaining to said credit account application of said user.

10. The associate-assisted method for a credit acquisition process of claim 9, wherein said associate device is selected from the group consisting of: a tablet, a mobile computing device, and the like.

11. The associate-assisted method for a credit acquisition process of claim 9, wherein said receiving, at said user's mobile device, data corresponding to said credit account application further comprises:
receiving, on said user's mobile device, an indication that said mobile device number corresponding to said user's mobile device has been successfully verified.

12. The associate-assisted method for a credit acquisition process of claim 9, wherein said receiving, at said user's mobile device, data corresponding to said credit account application further comprises:
receiving a uniform resource locator (URL) which said user can use to initiate said credit account application.

13. The associate-assisted method for a credit acquisition process of claim 9, wherein said receiving, at said user's mobile device, data corresponding to said credit account application further comprises:
receiving, on said user's mobile device, a one-time passcode (OTP).

14. The associate-assisted method for a credit acquisition process of claim 9, wherein said requesting said user, via said user's mobile device, to consent to said terms of said credit account application further comprises:
requiring said user to comply with obtain and retain requirements for said credit account application.

15. The associate-assisted method for a credit acquisition process of claim 9, wherein said utilizing said associate device to have said user electronically consent to a credit card agreement corresponding to said credit account further comprises:
utilizing said associate device to have said user confirm that information contained in said pre-filled version of said credit account application is accurate.

16. The associate-assisted method for a credit acquisition process of claim 9, further comprising:
provided said user is approved for said credit account, receiving an approval notification at said associate device.

17. The associate-assisted method for a credit acquisition process of claim 9, wherein said requesting said user, via said user's device, to consent to said terms of said credit account application further comprises:
requiring said user to consent to an agreement selected from the group consisting of: the electronic communications agreement, various terms and conditions, the electronic privacy policy & online privacy policy, and the like.

18. An associate-assisted method for a credit acquisition process, said method comprising:
a user receiving assistance with a credit account application for a credit account from a store associate, wherein said store associate presents, to said user, options for said credit account application via an associate device;
selecting said user's selected option for said credit account application via said associate device;
capturing, via said associate device, mobile device number corresponding to said user's mobile device;
using device verification methodologies to verify said user's mobile device;
receiving, via said associate device, consent from said user to receive data on said user's mobile device from a party handling said credit account application;
receiving, at said user's mobile device, data corresponding to said credit account application;
requesting said user, via said user's mobile device, to electronically consent to terms of said credit account application;
receiving, at said associate device, a pre-filled version of said credit account application;
utilizing said associate device to have said user electronically consent to a credit card agreement corresponding to said credit account; and
receiving, at said associate device, approval/denial information pertaining to said credit account application of said user.

19. The associate-assisted method for a credit acquisition process of claim 18, wherein said associate device is selected from the group consisting of: a tablet, a mobile computing device, and the like.

20. The associate-assisted method for a credit acquisition process of claim 18, wherein said using device verification methodologies to verify said user's mobile device further comprises:
using KYC/KYB (Know Your Customer/Know Your Business) methodologies to verify said user's mobile device.
